(19) United States
(12) Patent Application Publication
(10) Pub. No.: US 2020/0138548 A1
(43) Pub. Date: May 7, 2020

(54) BIOLOGICALLY FRIENDLY ORTHODONTIC ALIGNERS

(71) Applicant: Hui Feng, Shanghai (CN)

(72) Inventor: Hui Feng, Shanghai (CN)

(21) Appl. No.: 16/676,303

(22) Filed: Nov. 6, 2019

Related U.S. Application Data
(60) Provisional application No. 62/756,834, filed on Nov. 7, 2018.

(51) Int. Cl. A61C 7/08

(52) U.S. Cl. CPC A61C 7/08; A61C 7/10

(57) ABSTRACT

Provided herein is a system for tooth repositioning comprising appliances that comprise polymeric shells, where at least one shell of the polymeric shells has an occlusal side opening such that a tooth receiving the at least one shell has its occlusal surface exposed.

### CROSS-REFERENCE TO RELATED APPLICATIONS

This application claims the benefit of U.S. provisional application Ser. No. 62/756,834, filed Nov. 7, 2018, the teaching of which being incorporated herein by reference in its entirety.

### FIELD OF THE INVENTION

The present invention relates generally to the field of orthodontic technology.

### BACKGROUND OF THE INVENTION

Conventional method of repositioning teeth is to make users wear what are commonly referred to as “braces.” Braces include a variety of appliances such as brackets, archwires, ligatures, and O-rings. The procedures of conventional orthodontics are briefly described here: Before fastening braces to a user's teeth, at least one appointment is typically scheduled with the orthodontist, dentist, and/or X-ray laboratory so that X-rays and photographs of the user's teeth and jaw structure can be taken. Also during this preliminary meeting, or possibly at a later meeting, an alginate mold of the user's teeth is typically made. This mold provides a model of the user's teeth that the orthodontist uses in conjunction with the X-rays and photographs to formulate a treatment strategy. The orthodontist then typically schedules one or more appointments during which braces will be attached to the user's teeth.

At the meeting during which braces are first attached, the teeth surfaces are initially treated with a weak acid the acid optimizes the adhesion properties of the teeth surfaces for brackets and bands that are to be bonded to them. The brackets and bands serve as anchors for other appliances to be added later. After the acid step, the brackets and bands are cemented to the user's teeth using a suitable bonding material. No force-inducing appliances are added until the cement is set. For this reason, it is common for the orthodontist to schedule a later appointment to ensure that the brackets and bands are well bonded to the teeth.

The primary force-inducing appliance in a conventional set of braces is the archwire. The archwire is resilient and is attached to the brackets by way of slots in the brackets. The archwire links the brackets together and exerts forces on them to move the teeth over time. Twisted wires or elastomeric O-rings are commonly used to reinforce attachment of the archwire to the brackets. Attachment of the archwire to the brackets is known in the art of orthodontia as “ligation” and wires used in this procedure are called “ligatures.” The elastomeric O-rings are called “plastics.”

After the archwire is in place, periodic meetings with the orthodontist are required, during which the user's braces will be adjusted by installing a different archwire having different force inducing properties or by replacing or tightening existing ligatures. Typically, these meetings are scheduled every three to six weeks. Therefore, attaching the appliances to a user's teeth is tedious and time-consuming enterprise and requires many meetings with the treating orthodontist.

Various methods have been developed to simplify and to reduce the cost of orthodontics with limited success. For example, Kuroda et al. (1996) Am. J. Orthodontics 110:365-369 describes a method for laser scanning a plaster dental cast to produce a digital image of the cast. See also U.S. Pat. No. 5,605,459. U.S. Pat. Nos. 5,533,895; 5,474,448; 5,454,717; 5,447,432; 5,431,562; 5,395,238; 5,368,478; and 5,139,419, assigned to Ormco Corporation, describe methods for manipulating digital images of teeth for designing orthodontic appliances.

FIGS. 1A-1C show clear aligners. FIGS. 1A and 1B show clear aligners of a lower dental arch, having a labial/buccal side and a palatal/lingual side. FIG. 1C shows an aligner of an upper dental arch, having a labial/buccal side and a palatal/lingual side. FIG. 2 shows the left section of a lower dental arch where incisors, canine, premolars, and molar are labeled as such.

U.S. Pat. No. 5,011,405 describes a method for digitally imaging a tooth and determining optimum bracket positioning for orthodontic treatment. Laser scanning of a molded tooth to produce a three-dimensional model is described in U.S. Pat. No. 5,338,198. U.S. Pat. No. 5,452,219 describes a method for laser scanning a tooth model and milling a tooth mold. Digital computer manipulation of tooth contours is described in U.S. Pat. Nos. 5,607,305 and 5,587,912. Computerized digital imaging of the jaw is described in U.S. Pat. Nos. 5,342,202 and 5,340,309. Other patents of interest include U.S. Pat. Nos. 5,549,476; 5,382,164; 5,273,429; 4,936,862; 3,860,803; 3,660,900; 5,645,421; 5,055,039; 4,798,534; 4,856,991; 5,035,613; 5,059,118; 5,186,623; and 4,755,139.

U.S. Pat. Nos. 6,398,548 and 6,554,611 describes using a computer program predict the teeth movement from initial tooth positions to the final tooth positions and design and fabricate a series of appliances having different geometries to achieve the repositioning of the teeth from their initial positions to their final positions in one set of appliances in that the user receives a whole set of appliances from the beginning to the finish. The appliances are numbered or marked in the sequence for use. The problem is that if certain tooth movement is behind the expected tooth position, the discrepancy between actual tooth position and expected (predicted) tooth position will most likely increase further and further during the course of repositioning. In addition, teeth with increased discrepancies between actual and expected positions will experience a disproportionate load of force relative to the other teeth and lead to increased patient pain and discomfort.

A major shortcoming of the clear plastic orthodontic aligners is the discomfort wearing such aligners which enclose the whole tooth/teeth, resulting in lacking direct contact of the occlusal surfaces of teeth of the lower dental arch and these of the upper dental arch. Additionally, full enclosure of the entire surface of tooth/teeth also causes discomfort and potentially issues of dental hygiene as enclosed tooth surface could generate an enclosed friendly environment for oral bacteria, which is highly undesirable.

The embodiments described below address the above identified needs and issues.

### SUMMARY OF THE SYSTEM

In an aspect of the present invention, it is provided a system for a system for repositioning teeth of a user in need thereof from an initial tooth arrangement to a final tooth arrangement, the user having a dental arch that comprises malpositioned (“MP”) teeth and normal-positioned (“NP”) teeth, the system comprising one or more cycles of successive appliances, each cycle of successive appliances including: (a) at least one first appliance having a geometry selected to reposition the teeth from the initial tooth arrangement to a first intermediate arrangement or the final tooth arrangement; (b) optionally one or more intermediate appliances having geometries selected to progressively reposition the teeth from the first intermediate arrangement to successive intermediate arrangements including a last intermediate tooth arrangement; and (c) at least one final appliance having a geometry selected to progressively reposition the teeth from the initial tooth arrangement or the last intermediate arrangement to the final tooth arrangement,

wherein the appliances comprise successive locks having different geometries shaped to receive and allow the appliances to reposition teeth from one arrangement to a successive arrangement,

wherein the locks comprise polymeric shells having cavities shaped to receive MP teeth and cavities shaped to receive NP teeth so as to resiliently reposition teeth from one arrangement to a successive arrangement, each of the polymeric shells having a labile/buccal (“L/B”) wall and a palatal/lingual (“P/L”) wall,

wherein at least one shell of the polymeric shells has an occlusal side opening such that a tooth receiving the at least one shell has its occlusal surface exposed.

In some embodiments of invention system, optionally in combination with any of the embodiments disclosed herein, each of the polymeric shells has a L/B wall thickness (“L/BW thickness”) and a P/L wall thickness (“P/LW thickness”), the L/BW thickness being different from the P/LW thickness, and

wherein the L/BW thickness or P/LW thickness of cavities receiving MP teeth has a thickness that is higher than that of the cavities receiving the NP teeth in the first appliance and optional one or more intermediate appliances.

In some embodiments of invention system, optionally in combination with any of the embodiments disclosed herein, each cycle of successive appliances contains a customized force system prescribed by an orthodontic doctor or practitioner, the force system being defined by following directional pulling force components: labile/buccal (“L/B”)-direction pulling, palatal/lingual (“P/L”)-direction pulling, right-direction pulling, and left-direction pulling.

In some embodiments of invention system, optionally in combination with any of the embodiments disclosed herein, at least one polymeric shell has a L/B wall or P/L wall being partially or entirely removed such that a tooth receiving the at least one polymeric shell has its L/B or P/L surface partially or entirely exposed, the partially or entirely removed L/B wall or P/L wall being on the side against the direction of the pulling force.

In some embodiments of invention system, optionally in combination with any of the embodiments disclosed herein, each cycle contains a de-escalating, escalating, and/or combinations of de-escalating/escalating force system.

In some embodiments of invention system, optionally in combination with any of the embodiments disclosed herein, the system comprises at least two cycles of appliances.

In some embodiments of invention system, optionally in combination with any of the embodiments disclosed herein, the system comprises at least two first appliances which are identical to each other in geometries, materials forming the appliances, and physical dimensions.

In some embodiments of invention system, optionally in combination with any of the embodiments disclosed herein, the at least one of the appliances comprises a decorative element on a labial surface of the at least one of the appliances.

In some embodiments of invention system, optionally in combination with any of the embodiments disclosed herein, at least one of the appliances comprises a physiologically active agent.

In some embodiments of invention system, optionally in combination with any of the embodiments disclosed herein, the L/BW thickness or P/LW thickness of the cavities receiving MP teeth has a thickness that is from about 0.1 mm to about 2 mm higher than that of the cavities receiving the NP teeth.

In some embodiments of invention system, optionally in combination with any of the embodiments disclosed herein, either the L/BW thickness or P/LW thickness of the cavities receiving MP teeth has a thickness that is identical to that of the cavities receiving the NP teeth.

In some embodiments of invention system, optionally in combination with any of the embodiments disclosed herein, any of the cycles comprises two or more appliances, the subsequent appliance having a thickness that differs from the thickness of the prior appliance in the range from about 0.1 to about 2 mm.

In some embodiments of invention system, optionally in combination with any of the embodiments disclosed herein, at least a region of an individual lock or shell comprises two or more layers of a polymeric material.

In some embodiments of invention system, optionally in combination with any of the embodiments disclosed herein, at least a region of an individual lock or shell comprises a material reinforced with a structure selected from the group consisting of pieces, strips, wires, mesh, lattices, interpenetrating networks, networks and combinations thereof.

In another aspect of the present invention, it is provided a method of forming a system for repositioning teeth of a user in need thereof from an initial tooth arrangement to a final tooth arrangement, comprising

providing an appliance comprising locks having different geometries configured to receive and allow the appliance to reposition teeth from one arrangement to a successive arrangement, wherein the locks comprise polymeric shells having cavities shaped to receive malpositioned (“MP”) teeth and cavities shaped to receive normal-positioned (“NP”) teeth so as to resiliently reposition teeth from one arrangement to a successive arrangement, each of the polymeric shells having a labile/buccal (“LB”) wall and a palatal/lingual (“P/L”) wall, and wherein at least one shell of the polymeric shells has an occlusal side opening such that a tooth receiving the at least one shell has its occlusal surface exposed, and

forming the system,

wherein the system comprises one or more cycles of successive appliances, each cycle of successive appliances including: (a) at least one first appliance having a geometry selected to reposition the teeth from the initial tooth arrangement to a first intermediate arrangement or the final tooth arrangement; (b) optionally one or more intermediate appliances having geometries selected to progressively reposition the teeth from the first intermediate arrangement to successive intermediate arrangements including a last intermediate tooth arrangement; and (c) at least one final appliance having a geometry selected to progressively reposition the teeth from the initial tooth arrangement or the last intermediate arrangement to the final tooth arrangement,

wherein the appliances comprise successive locks having different geometries shaped to receive and allow the appliances to reposition teeth from one arrangement to a successive arrangement,

wherein the locks comprise polymeric shells having cavities shaped to receive MP teeth and cavities shaped to receive NP teeth so as to resiliently reposition teeth from one arrangement to a successive arrangement, each of the polymeric shells having a labile/buccal (“L/B”) wall and a palatal/lingual (“P/L”) wall, and

wherein at least one shell of the polymeric shells has an occlusal side opening such that a tooth receiving the at least one shell has its occlusal surface exposed.

In some embodiments of invention method, optionally in combination with any of the embodiments disclosed herein, each of the polymeric shells has a L/B wall thickness (“L/BW thickness”) and a P/L wall thickness (“P/LW thickness”), the L/BW thickness being different from the P/LW thickness, and

wherein the L/BW thickness or P/LW thickness of cavities receiving MP teeth has a thickness that is higher than that of the cavities receiving the NP teeth in the first appliance and optional one or more intermediate appliances.

In some embodiments of invention method, optionally in combination with any of the embodiments disclosed herein, each cycle of successive appliances contains a customized force system prescribed by an orthodontic doctor or practitioner, the force system being defined by following directional pulling force components: labile/buccal (“L/B”)-direction pulling, palatal/lingual (“P/L”)-direction pulling, right-direction pulling, and left-direction pulling.

In some embodiments of invention method, optionally in combination with any of the embodiments disclosed herein, at least one polymeric shell has a L/B wall or P/L wall being partially or entirely removed such that a tooth receiving the at least one polymeric shell has its L/B or P/L surface partially or entirely exposed, the partially or entirely removed L/B wall or P/L wall being on the side against the direction of the pulling force.

In some embodiments of invention method, optionally in combination with any of the embodiments disclosed herein, each cycle contains a de-escalating, escalating, and/or combinations of de-escalating/escalating force system.

In some embodiments of invention method, optionally in combination with any of the embodiments disclosed herein, the system comprises at least two cycles of appliances.

In some embodiments of invention method, optionally in combination with any of the embodiments disclosed herein, the system comprises at least two first appliances which are identical to each other in geometries, materials forming the appliances, and physical dimensions.

In some embodiments of invention method, optionally in combination with any of the embodiments disclosed herein, the at least one of the appliances comprises a decorative element on a labial surface of the at least one of the appliances.

In some embodiments of invention method, optionally in combination with any of the embodiments disclosed herein, at least one of the appliances comprises a physiologically active agent.

In some embodiments of invention method, optionally in combination with any of the embodiments disclosed herein, the L/BW thickness or P/LW thickness of the cavities receiving MP teeth has a thickness that is from about 0.1 mm to about 2 mm higher than that of the cavities receiving the NP teeth.

In some embodiments of invention method, optionally in combination with any of the embodiments disclosed herein, either the L/BW thickness or P/LW thickness of the cavities receiving MP teeth has a thickness that is identical to that of the cavities receiving the NP teeth.

In some embodiments of invention method, optionally in combination with any of the embodiments disclosed herein, any of the cycles comprises two or more appliances, the subsequent appliance having a thickness that differs from the thickness of the prior appliance in the range from about 0.1 to about 2 mm.

In some embodiments of invention method, optionally in combination with any of the embodiments disclosed herein, at least a region of an individual lock or shell comprises two or more layers of a polymeric material.

In some embodiments of invention method, optionally in combination with any of the embodiments disclosed herein, at least a region of an individual lock or shell comprises a material reinforced with a structure selected from the group consisting of pieces, strips, wires, mesh, lattices, interpenetrating networks, networks and combinations thereof.

In a further aspect of the present invention, it is provided a method of orthodontic treatment, comprising applying to a user in need thereof a system for repositioning teeth from an initial tooth arrangement to a final tooth arrangement, the system comprising one or more cycles of successive appliances, each cycle of successive appliances including: (a) at least one first appliance having a geometry selected to reposition the teeth from the initial tooth arrangement to a first intermediate arrangement or the final tooth arrangement; (b) optionally one or more intermediate appliances having geometries selected to progressively reposition the teeth from the first intermediate arrangement to successive intermediate arrangements including a last intermediate tooth arrangement; and (c) at least one final appliance having a geometry selected to progressively reposition the teeth from the initial tooth arrangement or the last intermediate arrangement to the final tooth arrangement,

wherein the appliances comprise successive locks having different geometries shaped to receive and allow the appliances to reposition teeth from one arrangement to a successive arrangement,

wherein the locks comprise polymeric shells having cavities shaped to receive MP teeth and cavities shaped to receive NP teeth so as to resiliently reposition teeth from one arrangement to a successive arrangement, each of the polymeric shells having a labile/buccal (“L/B”) wall and a palatal/lingual (“P/L”) wall,

wherein at least one shell of the polymeric shells has an occlusal side opening such that a tooth receiving the at least one shell has its occlusal surface exposed.

In some embodiments of invention method, optionally in combination with any of the embodiments disclosed herein, each of the polymeric shells has a L/B wall thickness (“L/BW thickness”) and a P/L wall thickness (“P/LW thickness”), the L/BW thickness being different from the P/LW thickness, and

wherein the L/BW thickness or P/LW thickness of cavities receiving MP teeth has a thickness that is higher than that of the cavities receiving the NP teeth in the first appliance and optional one or more intermediate appliances.

In some embodiments of invention method, optionally in combination with any of the embodiments disclosed herein, each cycle of successive appliances contains a customized force system prescribed by an orthodontic doctor or practitioner, the force system being defined by following directional pulling force components: labile/buccal (“L/B”)-direction pulling, palatal/lingual (“P/L”)-direction pulling, right-direction pulling, and left-direction pulling.

In some embodiments of invention method, optionally in combination with any of the embodiments disclosed herein, at least one polymeric shell has a L/B wall or P/L wall being partially or entirely removed such that a tooth receiving the at least one polymeric shell has its L/B or P/L surface partially or entirely exposed, the partially or entirely removed L/B wall or P/L wall being on the side against the direction of the pulling force.

In some embodiments of invention method, optionally in combination with any of the embodiments disclosed herein, each cycle contains a de-escalating, escalating, and/or combinations of de-escalating/escalating force system.

In some embodiments of invention method, optionally in combination with any of the embodiments disclosed herein, the system comprises at least two cycles of appliances.

In some embodiments of invention method, optionally in combination with any of the embodiments disclosed herein, the system comprises at least two first appliances which are identical to each other in geometries, materials forming the appliances, and physical dimensions.

In some embodiments of invention method, optionally in combination with any of the embodiments disclosed herein, the at least one of the appliances comprises a decorative element on a labial surface of the at least one of the appliances.

In some embodiments of invention method, optionally in combination with any of the embodiments disclosed herein, at least one of the appliances comprises a physiologically active agent.

In some embodiments of invention method, optionally in combination with any of the embodiments disclosed herein, the L/BW thickness or P/LW thickness of the cavities receiving MP teeth has a thickness that is from about 0.1 mm to about 2 mm higher than that of the cavities receiving the NP teeth.

In some embodiments of invention method, optionally in combination with any of the embodiments disclosed herein, either the L/BW thickness or P/LW thickness of the cavities receiving MP teeth has a thickness that is identical to that of the cavities receiving the NP teeth.

In some embodiments of invention method, optionally in combination with any of the embodiments disclosed herein, any of the cycles comprises two or more appliances, the subsequent appliance having a thickness that differs from the thickness of the prior appliance in the range from about 0.1 to about 2 mm.

In some embodiments of invention method, optionally in combination with any of the embodiments disclosed herein, at least a region of an individual lock or shell comprises two or more layers of a polymeric material.

In some embodiments of invention method, optionally in combination with any of the embodiments disclosed herein, at least a region of an individual lock or shell comprises a material reinforced with a structure selected from the group consisting of pieces, strips, wires, mesh, lattices, interpenetrating networks, networks and combinations thereof.

### BRIEF DESCRIPTION OF DRAWINGS

FIGS. 1A-1C show typical plastic appliances: 1A, 1B—for the lower dental arch, and 1C—for upper dental arch, where the polymer shells each receive and enclose the entire surface of a tooth on a dental arch

FIG. 2 shows the left side of human lower dental arch where incisors, canine, premolar, and molar teeth are labeled.

FIG. 3 illustrates the directional forces of a force system of an embodiment of invention.

FIGS. 4A and 4B illustrates an embodiment of the invention, where a polymeric shell has its occlusal side removed, and another shell has its palatal/lingual wall removed.

### DESCRIPTION OF DETAILED EMBODIMENTS

### Definitions

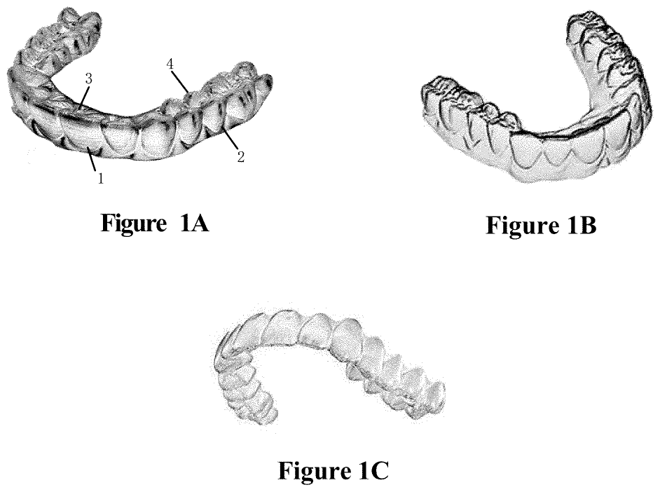

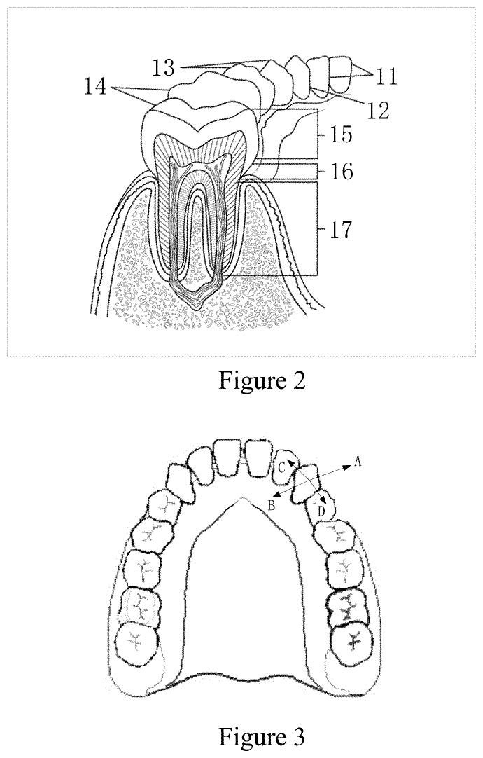

As used herein, the term “appliance” or “appliances” or “tray” or “trays” refer to a device having shells of a geometry defined by a dental arch of a user, each shell corresponding to one tooth on the dental arch and receiving only the one tooth. The appliance is formed of a plastic material and is generally clear and colorless. When an appliance or appliances are used to apply an orthodontic re-aligning or repositioning force on a tooth or teeth of a dental arch, the appliance or appliances are also called as “aligner” or “aligners”. FIGS. 1A-1C show typical plastic appliances: 1A, 1B—for the lower dental arch, and 1C—for upper dental arch, where the polymer shells each receive and enclose the entire surface of a tooth on a dental arch. Methods of forming an appliance is well documented, and examples of digital methods of forming an appliance are described in U.S. Pat. Nos. 5,605,459; 5,533,895; 5,474,448; 5,454,717; 5,447,432; 5,431,562; 5,395,238; 5,368,478; 5,139,419; 5,338,198; 5,452,219; 5,607,305; 5,587,912; 5,342,202; 5,340,309; 5,549,476; 5,382,164; 5,273,429; 4,936,862; 3,860,803; 3,660,900; 5,645,421; 5,055,039; 4,798,534; 4,856,991; 5,035,613; 5,059,118; 5,186,623; 4,755,139; 6,398,548 and 6,554,611. The teachings in each of these patents are incorporated herein in their entirety.

Whenever used, the term “duplicate” or “duplicates” or “copy” refers to appliances that are identical to each other with respect to geometries, materials forming the appliances, and/or physical dimensions of the appliances. Relatedly, the term “copy” of an appliance (“parent appliance”) refers to a copy appliance of the parent appliance that is identical to the parent appliance with respect to the geometries, materials forming the appliances, and/or physical dimensions of the appliances, and, in this context, the term “duplicate appliances” is used interchangeably with the term “duplicates” or “duplicate appliances” and refers to a copy appliance of the parent appliance that is identical to the parent appliance with respect to each of the geometries, materials forming the appliances, and physical dimensions of the appliances.

As used herein, the term “non-transparent” refers to the attribute of an appliance of invention that renders the original color of tooth/teeth of a user of the appliance invisible or substantially invisible.

As used herein, the term “translucent” refers to light being permitted to pass through but diffusing it so that persons, objects, etc., on the opposite side are not clearly visible.

As used herein, the term “physiologically active agent” refers to a chemical or biological compound effective for bringing about a physiological response in a user of the physiologically active agent. Such physiologically active agent can be therapeutic agent or a non-therapeutic agent.

Whenever used herein, the term “controlled release” or “controlled delivery” refers to release of a physiologically active agent in an effective amount from a system of invention into a user when the system is exposed to moisture in the oral cavity of a user of the appliance or the appliance is exposed to a fluid, e.g., saliva, of the user of appliance. Release of the physiologically active agent is controlled by the characteristics of the delivery module, which is described in more detail below.

Whenever used herein, the term “effective amount” refers to an amount of the physiologically active agent that produces a statistically significant positive result in a physiological condition in a user in need thereof as compared to a control not using the physiologically active agent. In this context, a physiological condition refers to a condition, which is also referred to as “disorder” or “disease” from time to time and requires medical attention, or a physiological condition that requires no medical attention, such as body odor, mouth odor, or bad breath, a condition of pure physiological pleasantness or lack thereof, such as flavor, taste, or a condition of desire, e.g., sexual attraction or lack thereof.

### System

In an aspect of the present invention, it is provided a system for a system for repositioning teeth of a user in need thereof from an initial tooth arrangement to a final tooth arrangement, the user having a dental arch that comprises malpositioned (“MP”) teeth and normal-positioned (“NP”) teeth, the system comprising one or more cycles of successive appliances, each cycle of successive appliances including: (a) at least one first appliance having a geometry selected to reposition the teeth from the initial tooth arrangement to a first intermediate arrangement or the final tooth arrangement; (b) optionally one or more intermediate appliances having geometries selected to progressively reposition the teeth from the first intermediate arrangement to successive intermediate arrangements including a last intermediate tooth arrangement; and (c) at least one final appliance having a geometry selected to progressively reposition the teeth from the initial tooth arrangement or the last intermediate arrangement to the final tooth arrangement,

wherein the appliances comprise successive locks having different geometries shaped to receive and allow the appliances to reposition teeth from one arrangement to a successive arrangement,

wherein the locks comprise polymeric shells having cavities shaped to receive MP teeth and cavities shaped to receive NP teeth so as to resiliently reposition teeth from one arrangement to a successive arrangement, each of the polymeric shells having a labile/buccal (“L/B”) wall and a palatal/lingual (“P/L”) wall,

wherein at least one shell of the polymeric shells has an occlusal side opening such that a tooth receiving the at least one shell has its occlusal surface exposed

In some embodiments of invention system, optionally in combination with any of the embodiments disclosed herein, each of the polymeric shells has a L/B wall thickness (“L/BW thickness”) and a P/L wall thickness (“P/LW thickness”), the L/BW thickness being different from the P/LW thickness, and

wherein the L/BW thickness or P/LW thickness of cavities receiving MP teeth has a thickness that is higher than that of the cavities receiving the NP teeth in the first appliance and optional one or more intermediate appliances.

In some embodiments of invention system, optionally in combination with any of the embodiments disclosed herein, each cycle of successive appliances contains a customized force system prescribed by an orthodontic doctor or practitioner, the force system being defined by following directional pulling force components: labile/buccal (“L/B”)-direction pulling, palatal/lingual (“P/L”)-direction pulling, right-direction pulling, and left-direction pulling.

In some embodiments of invention system, optionally in combination with any of the embodiments disclosed herein, at least one polymeric shell has a L/B wall or P/L wall being partially or entirely removed such that a tooth receiving the at least one polymeric shell has its L/B or P/L surface partially or entirely exposed, the partially or entirely removed L/B wall or P/L wall being on the side against the direction of the pulling force.

In some embodiments of invention system, optionally in combination with any of the embodiments disclosed herein, each cycle contains a de-escalating, escalating, and/or combinations of de-escalating/escalating force system.

In some embodiments of invention system, optionally in combination with any of the embodiments disclosed herein, the system comprises at least two cycles of appliances.

In some embodiments of invention system, optionally in combination with any of the embodiments disclosed herein, the system comprises at least two first appliances which are identical to each other in geometries, materials forming the appliances, and physical dimensions.

In some embodiments of invention system, optionally in combination with any of the embodiments disclosed herein, the at least one of the appliances comprises a decorative element on a labial surface of the at least one of the appliances.

In some embodiments of invention system, optionally in combination with any of the embodiments disclosed herein, at least one of the appliances comprises a physiologically active agent.

In some embodiments of invention system, optionally in combination with any of the embodiments disclosed herein, the L/BW thickness or P/LW thickness of the cavities receiving MP teeth has a thickness that is from about 0.1 mm to about 2 mm higher than that of the cavities receiving the NP teeth.

In some embodiments of invention system, optionally in combination with any of the embodiments disclosed herein, either the L/BW thickness or P/LW thickness of the cavities receiving MP teeth has a thickness that is identical to that of the cavities receiving the NP teeth.

In some embodiments of invention system, optionally in combination with any of the embodiments disclosed herein, any of the cycles comprises two or more appliances, the subsequent appliance having a thickness that differs from the thickness of the prior appliance in the range from about 0.1 to about 2 mm.

In some embodiments of invention system, optionally in combination with any of the embodiments disclosed herein, at least a region of an individual lock or shell comprises two or more layers of a polymeric material.

In some embodiments of invention system, optionally in combination with any of the embodiments disclosed herein, at least a region of an individual lock or shell comprises a material reinforced with a structure selected from the group consisting of pieces, strips, wires, mesh, lattices, interpenetrating networks, networks and combinations thereof.

In some embodiments of invention system, optionally in combination with any of the embodiments disclosed herein, the at least one first appliance, the optional one or more intermediate appliances, or the at least one final appliance comprise the decorative element on a labial side of the at least one first appliance, the optional one or more intermediate appliances, or the at least one final appliance.

In some embodiments of invention system, optionally in combination with any of the embodiments disclosed herein, the decorative element is formed using an additive or physical attachment or physical or chemical instrumentation.

In some embodiments of invention system, optionally in combination with any of the embodiments disclosed herein, the additive comprises a dye, microparticles or a glittering material; wherein the physical instrumentation comprises printing, mechanical carving, heat carving or laser etching; and wherein the chemical instrumentation comprises base or acid etching.

In some embodiments of invention system, optionally in combination with any of the embodiments disclosed herein, the decorative element comprises a non-transparent surface.

In some embodiments of invention system, optionally in combination with any of the embodiments disclosed herein, the decorative element comprises a glittering material.

In some embodiments of invention system, optionally in combination with any of the embodiments disclosed herein, the decorative element comprises a fragrance.

In some embodiments of invention system, optionally in combination with any of the embodiments disclosed herein, the decorative element comprises an organic or inorganic dye.

In some embodiments of invention system, optionally in combination with any of the embodiments disclosed herein, the non-transparent surface comprises microparticles.

In some embodiments of invention system, optionally in combination with any of the embodiments disclosed herein, the microparticles comprise an inorganic oxide, an inorganic salt, or a flavoring agent.

In some embodiments of invention system, optionally in combination with any of the embodiments disclosed herein, the decorative element comprises a glittering material.

In some embodiments of invention system, optionally in combination with any of the embodiments disclosed herein, the glittering material comprises organic crystals or inorganic crystals.

In some embodiments of invention system, optionally in combination with any of the embodiments disclosed herein, the glittering material comprises gold crystals, silver crystals, diamond crystals, or polymeric crystals.

In some embodiments of invention system, optionally in combination with any of the embodiments disclosed herein, the decorative element comprises a figurative element, a numeric element or an alphabetic element. Such figurative element can be, e.g., a shape of a start, a shape of heart, a human figure, an animal figure, a plant, a flower, a science or technology symbol, formula, or structure, an artistic work, a work of engineering, a natural scene, a pattern, or a design. Such alphabetic element can be, e.g., a name, a word, a short phrase, or letters such as name initials.

In some embodiments of invention system, optionally in combination with any of the embodiments disclosed herein, the decorative element comprises a tooth shape or color that makes up a defect in shape or structure of a tooth or a defect in color of a tooth; and the decorative element comprises a non-transparent or translucent white color to mask the tooth discoloration and/or to mask the defect in shape or structure of the tooth.

FIG. 3 illustrates an orthodontic force system of directional force components: 1—labial/buccal direction pulling, 2—palatal/lingual direction pulling, 3—right direction pulling, and 4—left direction pulling.

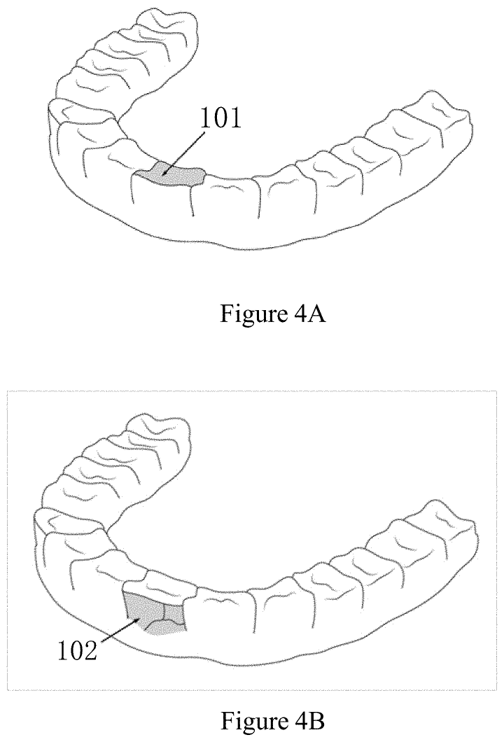

FIGS. 4A and 4B show an embodiment of invention appliance where a polymeric shell has its occlusal part, 5, removed and another has a part of palatal/lingual wall, 6, removed.

### Decorative Element

As used herein, the term “decorative element” refers to an element that is aesthetic appealing or matter of value of subjectivity to a user of the invention system disclosed herein.

A decorative element useful in the present invention can be any aesthetic features that formed of a biocompatible material. For example, a decorative element can comprise a non-transparent surface, an additive, a glittering material, a matter of color, such as an organic or inorganic dye or an object of physical or chemical instrumentation, a pattern, or design.

In some embodiments, the decorative element comprises a glittering material. Examples of glittering materials can be or can comprise, for example, organic crystals or inorganic crystals. In some further embodiments, a glittering material can comprise gold crystals, silver crystals, or diamond crystals.

In some embodiments, the decorative element can comprises a figurative element, a numeric element or an alphabetic element. Examples of such figurative element can be a shape of a start, a shape of heart, a human figure, an animal figure, a plant, a flower, a science or technology symbol, formula, or structure, an artistic work, a work of engineering, a natural scene, a pattern, or a design. In some embodiments, such figurative element can be of artistic work, e.g., drawing, painting, or sculpture, architecture, etc. In some further embodiments, such figurative element can be of work of engineering, e.g., a building or bridge. In some further embodiments, such figurative element can be of a natural scene, e.g., ocean, mountain, river, lake, tree, tree, forest, beach, or park.

In some embodiments, the decorative element can comprises a fragrance. Such fragrance can provide physiologically appealing senses, and, the fragrance can be, for example, senses of a scent, a sexual hormone, and/or a mouth-odor masking agent.

### Non-Transparent Surface

The non-transparent surface useful in the present invention can be formed of any biocompatible material(s). In some embodiments, the non-transparent surface can comprise microparticles. Such microparticles can comprise an inorganic oxide or an inorganic salt, for example. In some embodiments, the microparticles can comprise a material that is an oxide, a phosphate, a sulfate, a fluoride, chloride, a flavoring agent, a silicate, an aluminate, or a combination thereof.

In some further embodiments, the microparticles can comprise a material such as TiO₂, CaCO₃, Al₂O₃, SiO₂, a silicate, a sulfate, a phosphate, a fluoride, a chloride, a flavoring agent, or a combination thereof.

### Appliance-Forming Materials

The appliances can be formed of a plastic material such as a polyester. An example of such polyester is poly (lactic acid) (PLA) or a related material. Many types of polyester materials are developed for forming an appliance. Examples of such materials are also described in U.S. Pat. Nos. 5,605,459; 5,533,895; 5,474,448; 5,454,717; 5,447,432; 5,431,562; 5,395,238; 5,368,478; 5,139,419; 5,338,198; 5,452,219; 5,607,305; 5,587,912; 5,342,202; 5,340,309; 5,549,476; 5,382,164; 5,273,429; 4,936,862; 3,860,803; 3,660,900; 5,645,421; 5,055,039; 4,798,534; 4,856,991; 5,035,613; 5,059,118; 5,186,623; 4,755,139; 6,398,548 and 6,554,611. For concise of description, the teachings of appliance forming materials described in these patents are incorporated herein by reference in their entirety.

In some embodiments, the appliance forming material can also include an elastic material that may include one or more polymers. The polymer is preferably inert and biocompatible. The polymer is also sufficiently flexible to allow easy removal and application for the user, but also sufficiently rigid to allow controlled teeth movement. Any conventional material normally used in dental treatments for fabricating removable appliances can be used in this system. Specific examples of useful polymers include any elastic polymeric materials, such as those commonly used in the art of dentistry, e.g., olefin polymers or copolymers, such as polyethlyene, polybutylene, polyisobutylene, polypropylene, ethylene vinyl acetate, polyvinyl alcohol, polystyrene, copolymers that include two or more of ethylene, propylene, butylene, isobutene, pentene, styene, vinyl acetate, vinyl alcohol and a combination thereof, or a mixture thereof. The polymeric material may further include a material to modify the biocompatibility. Such biocompatibility modifying materials include, e.g., polyethylene glycol, polypropylene glycol, polyethylene oxide or a natural polymer such as cellulose or alginate, collagen, and the like.

In some embodiment, the polymeric materials may further include a reinforcing material such as fibers, chips, wires, glass fibers, carbon fibers, pieces, strips, mesh, lattices, and networks and interpenetrating networks. Some representative reinforcing materials include, for example, micro or nano aluminum oxide phases, carbon fibers, etc., or mixtures thereof.

### Method of Fabrication

In another aspect of the present invention, it is provided a method of forming a system for repositioning teeth of a user in need thereof from an initial tooth arrangement to a final tooth arrangement, comprising

providing an appliance comprising locks having different geometries configured to receive and allow the appliance to reposition teeth from one arrangement to a successive arrangement, wherein the locks comprise polymeric shells having cavities shaped to receive malpositioned (“MP”) teeth and cavities shaped to receive normal-positioned (“NP”) teeth so as to resiliently reposition teeth from one arrangement to a successive arrangement, each of the polymeric shells having a labile/buccal (“LB”) wall and a palatal/lingual (“P/L”) wall, and wherein at least one shell of the polymeric shells has an occlusal side opening such that a tooth receiving the at least one shell has its occlusal surface exposed; and

forming the system.

wherein the system comprises one or more cycles of successive appliances, each cycle of successive appliances including: (a) at least one first appliance having a geometry selected to reposition the teeth from the initial tooth arrangement to a first intermediate arrangement or the final tooth arrangement; (b) optionally one or more intermediate appliances having geometries selected to progressively reposition the teeth from the first intermediate arrangement to successive intermediate arrangements including a last intermediate tooth arrangement; and (c) at least one final appliance having a geometry selected to progressively reposition the teeth from the initial tooth arrangement or the last intermediate arrangement to the final tooth arrangement,

wherein the appliances comprise successive locks having different geometries shaped to receive and allow the appliances to reposition teeth from one arrangement to a successive arrangement,

wherein the locks comprise polymeric shells having cavities shaped to receive MP teeth and cavities shaped to receive NP teeth so as to resiliently reposition teeth from one arrangement to a successive arrangement, each of the polymeric shells having a labile/buccal (“L/B”) wall and a palatal/lingual (“P/L”) wall, and

wherein at least one shell of the polymeric shells has an occlusal side opening such that a tooth receiving the at least one shell has its occlusal surface exposed.

In some embodiments of invention method, optionally in combination with any of the embodiments disclosed herein, each of the polymeric shells has a UIB wall thickness (“L/BW thickness”) and a P/L wall thickness (“P/LW thickness”), the L/BW thickness being different from the P/LW thickness, and

wherein the L/BW thickness or P/LW thickness of cavities receiving MP teeth has a thickness that is higher than that of the cavities receiving the NP teeth in the first appliance and optional one or more intermediate appliances.

In some embodiments of invention method, optionally in combination with any of the embodiments disclosed herein, each cycle of successive appliances contains a customized force system prescribed by an orthodontic doctor or practitioner, the force system being defined by following directional pulling force components: labile/buccal (“LB”)-direction pulling, palatal/lingual (“P/L”)-direction pulling, right-direction pulling, and left-direction pulling.

In some embodiments of invention method, optionally in combination with any of the embodiments disclosed herein, at least one polymeric shell has a L/B wall or P/L wall being partially or entirely removed such that a tooth receiving the at least one polymeric shell has its UB or P/L surface partially or entirely exposed, the partially or entirely removed L/B wall or P/L wall being on the side against the direction of the pulling force.

In some embodiments of invention method, optionally in combination with any of the embodiments disclosed herein, each cycle contains a de-escalating, escalating, and/or combinations of de-escalating/escalating force system.

In some embodiments of invention method, optionally in combination with any of the embodiments disclosed herein, the system comprises at least two cycles of appliances.

In some embodiments of invention method, optionally in combination with any of the embodiments disclosed herein, the system comprises at least two first appliances which are identical to each other in geometries, materials forming the appliances, and physical dimensions.

In some embodiments of invention method, optionally in combination with any of the embodiments disclosed herein, the at least one of the appliances comprises a decorative element on a labial surface of the at least one of the appliances.

In some embodiments of invention method, optionally in combination with any of the embodiments disclosed herein, at least one of the appliances comprises a physiologically active agent.

In some embodiments of invention method, optionally in combination with any of the embodiments disclosed herein, the L/BW thickness or P/LW thickness of the cavities receiving MP teeth has a thickness that is from about 0.1 mm to about 2 mm higher than that of the cavities receiving the NP teeth.

In some embodiments of invention method, optionally in combination with any of the embodiments disclosed herein, either the L/BW thickness or P/LW thickness of the cavities receiving MP teeth has a thickness that is identical to that of the cavities receiving the NP teeth.

In some embodiments of invention method, optionally in combination with any of the embodiments disclosed herein, any of the cycles comprises two or more appliances, the subsequent appliance having a thickness that differs from the thickness of the prior appliance in the range from about 0.1 to about 2 mm.

In some embodiments of invention method, optionally in combination with any of the embodiments disclosed herein, at least a region of an individual lock or shell comprises two or more layers of a polymeric material.

In some embodiments of invention method, optionally in combination with any of the embodiments disclosed herein, at least a region of an individual lock or shell comprises a material reinforced with a structure selected from the group consisting of pieces, strips, wires, mesh, lattices, interpenetrating networks, networks and combinations thereof.

In some embodiments of invention method, optionally in combination with any of the embodiments disclosed herein, the at least one first appliance, the optional one or more intermediate appliances, or the at least one final appliance comprise the decorative element on a labial side of the at least one first appliance, the optional one or more intermediate appliances, or the at least one final appliance.

In some embodiments of invention method, optionally in combination with any of the embodiments disclosed herein, the decorative element is formed using an additive or physical attachment or physical or chemical instrumentation.

In some embodiments of invention method, optionally in combination with any of the embodiments disclosed herein, the additive comprises a dye, microparticles or a glittering material; wherein the physical instrumentation comprises printing, mechanical carving, heat carving or laser etching and wherein the chemical instrumentation comprises base or acid etching.

In some embodiments of invention method, optionally in combination with any of the embodiments disclosed herein, the decorative element comprises a non-transparent surface.

In some embodiments of invention method, optionally in combination with any of the embodiments disclosed herein, the decorative element comprises a glittering material.

In some embodiments of invention method, optionally in combination with any of the embodiments disclosed herein, the decorative element comprises a fragrance.

In some embodiments of invention method, optionally in combination with any of the embodiments disclosed herein, the decorative element comprises an organic or inorganic dye.

In some embodiments of invention method, optionally in combination with any of the embodiments disclosed herein, the non-transparent surface comprises microparticles.

In some embodiments of invention method, optionally in combination with any of the embodiments disclosed herein, the microparticles comprise an inorganic oxide, an inorganic salt, or a flavoring agent.

In some embodiments of invention method, optionally in combination with any of the embodiments disclosed herein, the decorative element comprises a glittering material.

In some embodiments of invention system, optionally in combination with any of the embodiments disclosed herein, the glittering material comprises organic crystals or inorganic crystals.

In some embodiments of invention method, optionally in combination with any of the embodiments disclosed herein, the glittering material comprises gold crystals, silver crystals, diamond crystals, or polymeric crystals.

In some embodiments of invention method, optionally in combination with any of the embodiments disclosed herein, the decorative element comprises a figurative element, a numeric element or an alphabetic element. Such figurative element can be, e.g., a shape of a start, a shape of heart, a human figure, an animal figure, a plant, a flower, a science or technology symbol, formula, or structure, an artistic work, a work of engineering, a natural scene, a pattern, or a design. Such alphabetic element can be, e.g., a name, a word, a short phrase, or letters such as name initials.

In some embodiments of invention method, optionally in combination with any of the embodiments disclosed herein, the decorative element comprises a tooth shape or color that makes up a defect in shape or structure of a tooth or a defect in color of a tooth; and the decorative element comprises a non-transparent or translucent white color to mask the tooth discoloration and/or to mask the defect in shape or structure of the tooth.

### Method of Forming Appliances

The appliance, as an orthodontic aligner, can be formed by (a) receiving prescribed orthodontic information for a user in need of orthodontic treatment, (b) forming a cycle of appliances comprising individual appliances, and (c) forming a cycle of appliances.

Generally, the appliances can be formed by (1) generating/obtaining an initial data set such as an initial digital data set (IDDS) representing the initial tooth arrangement, (2) generating a digital data set (DDS) or non-digital data set (NDDS) representing an intermediate tooth arrangement, (3) generating an end or a final data set such as a DDS or NDDS representing an end tooth arrangement or a final tooth arrangement, and (4) optionally producing a plurality of successive digital data sets based on both of the first digital data set and the final digital data set, wherein the plurality of successive data sets represent a series of successive tooth arrangements progressing from the intermediate tooth arrangement last end tooth arrangement to the end tooth arrangement or the final tooth arrangement, and (5) forming an appliance or a plurality of appliances based on the digital data sets. In some embodiments, the digital data sets can be converted into visual images representing a tooth arrangement, and the appliances can be formed based on the visual images. Methods of obtaining the IDDS and DDS, generating a visual image based on DDS and forming an appliance based on the visual image are described in U.S. Pat. Nos. 6,398,548; 6,544,611; 5,895,893; 6,244,861; 6,616,444; 5,645,420; and 5,447,432, the teachings of which are incorporated herein by reference.

The initial digital data set may be provided by any techniques known in the art, including digitizing X-ray images, images produced by computer-aided tomography (CAT scans), images produced by magnetic resonance imaging (MRI), images produced by photo scanning, and the like. The images will be three-dimensional images and digitization may be accomplished using known technology. For example, the initial digital data set is provided by producing a plaster cast of the user's teeth (prior to treatment) by techniques known in the art. The plaster cast so produced may then be scanned using laser or other scanning equipment to produce a high resolution digital representation of the plaster cast of the user's teeth.

In a preferred embodiment, a wax bite is also obtained from the user using standard methods. The wax bite allows plaster casts of a user's upper and lower dentition to be placed relative to one another in the centric occlusal position. The pair of casts then can be scanned to provide information on the relative position of the jaw in this position. This information is then incorporated into the IDDS for both arches.

Once the digital data set is acquired, an image can be presented and manipulated on a suitable computer system equipped with computer-aided design software, as described in greater detail below. The image manipulation will usually comprise defining boundaries about at least some of the individual teeth, and causing the images of the teeth to be moved relative to the jaw and other teeth by manipulation of the image via the computer. Methods are also provided for detecting cusp information for the teeth. The image manipulation can be done entirely subjectively, i.e. the user may simply reposition teeth in an aesthetically and/or therapeutically desired manner based on observation of the image alone. Alternatively, the computer system could be provided with rules and algorithms which assist the user in repositioning the teeth. In some instances, it will be possible to provide rules and algorithms which reposition the teeth in a fully automatic manner, i.e. without user intervention. Once the individual teeth have been repositioned, a final digital data set representing the desired final tooth arrangement will be generated and stored.

An exemplary method for determining the final tooth arrangement is for the treating professional to define the final tooth positions, e.g. by writing a prescription. The use of prescriptions for defining the desired outcomes of orthodontic procedures is well known in the art. When a prescription or other final designation is provided, the image can then be manipulated to match the prescription. In some cases, it would be possible to provide software which could interpret the prescription in order to generate the final image and thus the digital data set representing the final tooth arrangement.

In yet another embodiments, methods described herein are provided for producing a plurality of digital data sets representing a series of discrete tooth arrangements progressing from an initial tooth arrangement to a final tooth arrangement. Such methods comprise providing a digital data set representing an initial tooth arrangement (which may be accomplished according to any of the techniques set forth above). A digital data set representing a final tooth arrangement is also provided. Such final digital data set may be determined by the methods described previously. A plurality of successive digital or non-digital data sets are then produced based on the initial digital data set and the final digital data set. Usually, the successive digital data sets are produced by determining positional differences between selected individual teeth in the initial data set and in the final data set and interpolating said differences. Such interpolation may be performed over as many discrete stages as may be desired, usually at least three, often at least four, more often at least ten, sometimes at least twenty-five, and occasionally forty or more. Many times, the interpolation will be linear interpolation for some or all of the positional differences. Alternatively, the interpolation may be non-linear. In a preferred embodiment, non-linear interpolation is computed automatically by the computer using path scheduling and collision detection techniques to avoid interferences between individual teeth. The positional differences will correspond to tooth movements where the maximum linear movement of any point on a tooth is 2 mm or less, usually being 1 mm or less, and often being 0.5 mm or less.

Often, the user will specify certain target intermediate tooth arrangements, referred to as “key frames,” which are incorporated directly into the intermediate digital data sets. The methods of the present system then determine successive digital data sets between the key frames in the manner described above, e.g. by linear or non-linear interpolation between the key frames. The key frames may be determined by a user, e.g. the individual manipulating a visual image at the computer used for generating the digital data sets, or alternatively may be provided by the treating professional as a prescription in the same manner as the prescription for the final tooth arrangement.

In still another embodiments, methods described herein provide for fabricating a plurality of dental incremental position adjustment appliances. Said methods comprise providing an initial digital data set, a final digital or non-digital data set, and producing a plurality of successive digital or non-digital data sets representing the target successive tooth arrangements, generally as just described. The dental appliances are then fabricated based on at least some of the digital data sets representing the successive tooth arrangements. Preferably, the fabricating step comprises controlling a fabrication machine based on the successive digital data sets to produce successive positive models of the desired tooth arrangements. The dental appliances are then produced as negatives of the positive models using conventional positive pressure or vacuum fabrication techniques. The fabrication machine may comprise a stereolithography or other similar machine which relies on selectively hardening a volume of non-hardened polymeric resin by scanning a laser to selectively harden the resin in a shape based on the digital data set. Other fabrication machines which could be utilized in the methods of the present system include tooling machines and wax deposition machines.

In still another embodiment, methods of the present system for fabricating a dental appliance comprise providing a digital data set representing a modified tooth arrangement for a user. A fabrication machine is then used to produce a positive model of the modified tooth arrangement based on the digital data set. The dental appliance is then produced as a negative of the positive model. The fabrication machine may be a stereolithography or other machine as described above, and the positive model is produced by conventional pressure or vacuum molding techniques.

In some embodiments, methods for fabricating a dental appliance described herein comprise providing a first digital data set representing a modified tooth arrangement for a user. A second digital data set is then produced from the first digital data set, where the second data set represents a negative model of the modified tooth arrangement. The fabrication machine is then controlled based on the second digital data set to produce the dental appliance. The fabrication machine will usually rely on selectively hardening a non-hardened resin to produce the appliance. The appliance typically comprises a polymeric shell having a cavity shape to receive and resiliently reposition teeth from an initial tooth arrangement to the modified tooth arrangement.

In some embodiments, the orthodontic doctor can take an imprint or scan a last intermediate tooth arrangement after the user has undergone the treatment of one or more cycles of appliances. A digital data set of the last intermediate tooth arrangement of the previous cycle thus can be obtained based on the imprint or scan. This digital data set of the last intermediate tooth arrangement of the previous cycle is then used as the initial point for generating a new set of digital data and visual images based on the new set of digital data representing one or more new intermediate tooth arrangements and a final tooth arrangement for the fabrication of a new cycle of appliances.

In some embodiments, the final tooth arrangement can be achieved with the application of two or more cycles of appliances, and each cycle of the appliances incrementally move the teeth starting from the tooth arrangement positioned by the last appliance of the previous cycle. Cycles of appliances can therefore be made according to the principles described above.

### Method of Use

In a further aspect of the present invention, it is provided a method of orthodontic treatment, comprising applying to a user in need thereof a system for repositioning teeth from an initial tooth arrangement to a final tooth arrangement, the system comprising one or more cycles of successive appliances, each cycle of successive appliances including: (a) at least one first appliance having a geometry selected to reposition the teeth from the initial tooth arrangement to a first intermediate arrangement or the final tooth arrangement; (b) optionally one or more intermediate appliances having geometries selected to progressively reposition the teeth from the first intermediate arrangement to successive intermediate arrangements including a last intermediate tooth arrangement; and (c) at least one final appliance having a geometry selected to progressively reposition the teeth from the initial tooth arrangement or the last intermediate arrangement to the final tooth arrangement,

wherein the appliances comprise successive locks having different geometries shaped to receive and allow the appliances to reposition teeth from one arrangement to a successive arrangement,

wherein the locks comprise polymeric shells having cavities shaped to receive MP teeth and cavities shaped to receive NP teeth so as to resiliently reposition teeth from one arrangement to a successive arrangement, each of the polymeric shells having a labile/buccal (“L/B”) wall and a palatal/lingual (“P/L”) wall,

wherein at least one shell of the polymeric shells has an occlusal side opening such that a tooth receiving the at least one shell has its occlusal surface exposed

In some embodiments of invention method, optionally in combination with any of the embodiments disclosed herein, each of the polymeric shells has a UIB wall thickness (“L/BW thickness”) and a P/L wall thickness (“P/LW thickness”), the L/BW thickness being different from the P/LW thickness, and

wherein the L/BW thickness or P/LW thickness of cavities receiving MNP teeth has a thickness that is higher than that of the cavities receiving the NP teeth in the first appliance and optional one or more intermediate appliances.

In some embodiments of invention method, optionally in combination with any of the embodiments disclosed herein, each cycle of successive appliances contains a customized force system prescribed by an orthodontic doctor or practitioner, the force system being defined by following directional pulling force components: labile/buccal (“LB”)-direction pulling, palatal/lingual (“P/L”)-direction pulling, right-direction pulling, and left-direction pulling.

In some embodiments of invention method, optionally in combination with any of the embodiments disclosed herein, at least one polymeric shell has a L/B wall or P/L wall being partially or entirely removed such that a tooth receiving the at least one polymeric shell has its L/B or P/L surface partially or entirely exposed, the partially or entirely removed L/B wall or P/L wall being on the side against the direction of the pulling force.

In some embodiments of invention method, optionally in combination with any of the embodiments disclosed herein, each cycle contains a de-escalating, escalating, and/or combinations of de-escalating/escalating force system.

In some embodiments of invention method, optionally in combination with any of the embodiments disclosed herein, the system comprises at least two cycles of appliances.

In some embodiments of invention method, optionally in combination with any of the embodiments disclosed herein, the system comprises at least two first appliances which are identical to each other in geometries, materials forming the appliances, and physical dimensions.

In some embodiments of invention method, optionally in combination with any of the embodiments disclosed herein, the at least one of the appliances comprises a decorative element on a labial surface of the at least one of the appliances.

In some embodiments of invention method, optionally in combination with any of the embodiments disclosed herein, at least one of the appliances comprises a physiologically active agent.

In some embodiments of invention method, optionally in combination with any of the embodiments disclosed herein, the L/BW thickness or P/LW thickness of the cavities receiving MP teeth has a thickness that is from about 0.1 mm to about 2 mm higher than that of the cavities receiving the NP teeth.

In some embodiments of invention method, optionally in combination with any of the embodiments disclosed herein, either the L/BW thickness or P/LW thickness of the cavities receiving MP teeth has a thickness that is identical to that of the cavities receiving the NP teeth.

In some embodiments of invention method, optionally in combination with any of the embodiments disclosed herein, any of the cycles comprises two or more appliances, the subsequent appliance having a thickness that differs from the thickness of the prior appliance in the range from about 0.1 to about 2 mm.

In some embodiments of invention method, optionally in combination with any of the embodiments disclosed herein, at least a region of an individual lock or shell comprises two or more layers of a polymeric material.

In some embodiments of invention method, optionally in combination with any of the embodiments disclosed herein, at least a region of an individual lock or shell comprises a material reinforced with a structure selected from the group consisting of pieces, strips, wires, mesh, lattices, interpenetrating networks, networks and combinations thereof.

In some embodiments of invention method, optionally in combination with any of the embodiments disclosed herein, the at least one first appliance, the optional one or more intermediate appliances, or the at least one final appliance comprise the decorative element on a labial side of the at least one first appliance, the optional one or more intermediate appliances, or the at least one final appliance.

In some embodiments of invention method, optionally in combination with any of the embodiments disclosed herein, the decorative element is formed using an additive or physical attachment or physical or chemical instrumentation.

In some embodiments of invention method, optionally in combination with any of the embodiments disclosed herein, the additive comprises a dye, microparticles or a glittering material; wherein the physical instrumentation comprises printing, mechanical carving, heat carving or laser etching; and wherein the chemical instrumentation comprises base or acid etching.

In some embodiments of invention method, optionally in combination with any of the embodiments disclosed herein, the decorative element comprises a non-transparent surface.

In some embodiments of invention method, optionally in combination with any of the embodiments disclosed herein, the decorative element comprises a glittering material.

In some embodiments of invention method, optionally in combination with any of the embodiments disclosed herein, the decorative element comprises a fragrance.

In some embodiments of invention method, optionally in combination with any of the embodiments disclosed herein, the decorative element comprises an organic or inorganic dye.

In some embodiments of invention method, optionally in combination with any of the embodiments disclosed herein, the non-transparent surface comprises microparticles.

In some embodiments of invention method, optionally in combination with any of the embodiments disclosed herein, the microparticles comprise an inorganic oxide, an inorganic salt, or a flavoring agent.

In some embodiments of invention method, optionally in combination with any of the embodiments disclosed herein, the decorative element comprises a glittering material.

In some embodiments of invention system, optionally in combination with any of the embodiments disclosed herein, the glittering material comprises organic crystals or inorganic crystals.

In some embodiments of invention method, optionally in combination with any of the embodiments disclosed herein, the glittering material comprises gold crystals, silver crystals, diamond crystals, or polymeric crystals.

In some embodiments of invention method, optionally in combination with any of the embodiments disclosed herein, the decorative element comprises a figurative element, a numeric element or an alphabetic element. Such figurative element can be, e.g., a shape of a start, a shape of heart, a human figure, an animal figure, a plant, a flower, a science or technology symbol, formula, or structure, an artistic work, a work of engineering, a natural scene, a pattern, or a design. Such alphabetic element can be, e.g., a name, a word, a short phrase, or letters such as name initials.

In some embodiments of invention method, optionally in combination with any of the embodiments disclosed herein, the decorative element comprises a tooth shape or color that makes up a defect in shape or structure of a tooth or a defect in color of a tooth; and the decorative element comprises a non-transparent or translucent white color to mask the tooth discoloration and/or to mask the defect in shape or structure of the tooth.

While the above is a complete description of the preferred embodiments of the system, various alternatives, modifications, and equivalents may be used. Therefore, the above description should not be taken as limiting the scope of the system which is defined by the appended claims.

I claim:

1. A system for repositioning teeth of a user in need thereof from an initial tooth arrangement to a final tooth arrangement, the user having a dental arch that comprises malpositioned (“MP”) teeth and normal-positioned (“NP”) teeth, the system comprising one or more cycles of successive appliances, each cycle of successive appliances including: (a) at least one first appliance having a geometry selected to reposition the teeth from the initial tooth arrangement to a first intermediate arrangement or the final tooth arrangement; (b) optionally one or more intermediate appliances having geometries selected to progressively reposition the teeth from the first intermediate arrangement to successive intermediate arrangements including a last intermediate tooth arrangement; and (c) at least one final appliance having a geometry selected to progressively reposition the teeth from the initial tooth arrangement or the last intermediate arrangement to the final tooth arrangement,
wherein the appliances comprise successive locks having different geometries shaped to receive and allow the appliances to reposition teeth from one arrangement to a successive arrangement,
wherein the locks comprise polymeric shells having cavities shaped to receive MP teeth and cavities shaped to receive NP teeth so as to resiliently reposition teeth from one arrangement to a successive arrangement, each of the polymeric shells having a labile/buccal (“L/B”) wall and a palatal/lingual (“P/L”) wall,
wherein at least one shell of the polymeric shells has an occlusal side opening such that a tooth receiving the at least one shell has its occlusal surface exposed.

2. The system according to claim 1, wherein each of the polymeric shells has a L/B wall thickness (“L/BW thickness”) and a P/L wall thickness (“P/LW thickness”), the L/BW thickness being different from the P/LW thickness, and
wherein the L/BW thickness or P/LW thickness of cavities receiving MP teeth has a thickness that is higher than that of the cavities receiving the NP teeth in the first appliance and optional one or more intermediate appliances.

3. The system according to claim 1, wherein each cycle of successive appliances contains a customized force system prescribed by an orthodontic doctor or practitioner, the force system being defined by following directional pulling force components: labile/buccal (“I/B”)-direction pulling, palatal/lingual (“P/L”)-direction pulling, right-direction pulling, and left-direction pulling.

4. The system according to claim 3, wherein the at least one polymeric shell has a L/B wall or P/L wall being partially or entirely removed such that a tooth receiving the at least one polymeric shell has its L/B or P/L surface partially or entirely exposed, the partially or entirely removed LB wall or P/L wall being on the side against the direction of the pulling force.

5. The system of claim 1, wherein each cycle contains a de-escalating, escalating, and/or combinations of de-escalating/escalating force system.

6. The system of claim 1, comprising at least two cycles of appliances.

7. The system of claim 1, comprising at least two first appliances which are identical to each other in geometries, materials forming the appliances, and physical dimensions.

8. The system of claim 1, wherein at least one of the appliances comprises a decorative element on a labial surface of the at least one of the appliances.

9. The system according to claim 1, wherein at least one of the appliances comprises a physiologically active agent.

10. The system of claim 1, wherein the L/BW thickness or P/LW thickness of the cavities receiving MP teeth has a thickness that is from about 0.1 mm to about 2 mm higher than that of the cavities receiving the NP teeth.

11. The system of claim 1, wherein either the L/BW thickness or P/LW thickness of the cavities receiving MP teeth has a thickness that is identical to that of the cavities receiving the NP teeth.

12. The system of claim 1, where any of the cycles comprises two or more appliances, the subsequent appliance having a thickness that differs from the thickness of the prior appliance in the range from about 0.1 to about 2 mm.

13. The system of claim 1, wherein at least a region of an individual lock or shell comprises two or more layers of a polymeric material.

14. The system of claim 1, wherein at least a region of an individual lock or shell comprises a material reinforced with a structure selected from the group consisting of pieces, strips, wires, mesh, lattices, interpenetrating networks, networks and combinations thereof.

15. A method of forming a system for repositioning teeth of a user in need thereof from an initial tooth arrangement to a final tooth arrangement, comprising
providing an appliance comprising locks having different geometries configured to receive and allow the appliance to reposition teeth from one arrangement to a successive arrangement, wherein the locks comprise polymeric shells having cavities shaped to receive malpositioned (“MP”) teeth and cavities shaped to receive normal-positioned (“NP”) teeth so as to resiliently reposition teeth from one arrangement to a successive arrangement, each of the polymeric shells having a labile/buccal (“L/B”) wall and a palatal/lingual (“P/L”) wall, and wherein at least one shell of the polymeric shells has an occlusal side opening such that a tooth receiving the at least one shell has its occlusal surface exposed; and
forming the system according to claim 1.

16. A method of orthodontic treatment, comprising applying to a user in need thereof a system for repositioning teeth from an initial tooth arrangement to a final tooth arrangement, the system is according to claim 1.
